(19) United States
(12) Patent Application Publication
(10) Pub. No.: US 2015/0039593 A1
(43) Pub. Date: Feb. 5, 2015

(54) PRE-DELIVERY OF CONTENT TO A USER DEVICE

(71) Applicant: Opanga Networks, Inc., Seattle, WA (US)

(72) Inventors: Jeffrey Paul HARRANG, Seattle, WA (US); Cory GABRIELSEN, Seattle, WA (US); Ben HADORN, Seattle, WA (US); John BURNETTE, Seattle, WA (US); Linh NGUYEN, Seattle, WA (US); David GIBBONS, Seattle, WA (US)

(21) Appl. No.: 14/448,957

(22) Filed: Jul. 31, 2014

Related U.S. Application Data
(63) Continuation of application No. 14/448,876, filed on Jul. 31, 2014.
(60) Provisional application No. 61/860,797, filed on Jul. 31, 2013.
(60) Provisional application No. 61/864,722, filed on Aug. 12, 2013.
(60) Provisional application No. 61/943,529, filed on Feb. 24, 2014.

(51) Int. Cl. G06F 17/30; G06F 3/0484; G06F 3/0482

(52) U.S. Cl. CPC G06F 17/30867; G06F 3/0482; G06F 3/04842
USPC 707/722

(57) ABSTRACT

Systems and methods for delivering content to user devices before the content is selected or requested (e.g., a pre-delivery of content) are described. In some embodiments, the system and methods receive, from a content server, information associated with content items available for retrieval from the content server and associated with one or more applications resident on a user device, select a subset of content items from the content items available for retrieval to deliver to the user device based on content usage information associated with the user device, and cause the user device to retrieve at least a portion of the selected subset of content items from the content server.

### CROSS-REFERENCES TO RELATED APPLICATIONS

This application is a continuation of and claims priority to U.S. Non-provisional application Ser. No. 14/448,876, filed on Jul. 31, 2014, which claims priority to U.S. Provisional Application No. 61/860,797, filed on Jul. 31, 2013, entitled METHOD AND SYSTEM FOR PRE-DELIVERED CONTENT LEARNING, U.S. Provisional Application No. 61/864,722, filed on Aug. 12, 2013, entitled METHOD AND SYSTEM FOR PREDICTING USER PREFERENCE OF CONTENT ITEM VERSUS COST OF CONTENT DELIVERY, and U.S. Provisional Application No. 61/943,529, filed on Feb. 24, 2014, entitled APPLICATION FOR ENHANCED VIDEO PLAYBACK OF MOBILE VIDEO CONTENT, which are hereby incorporated by reference in their entirety.

### BACKGROUND

Many user devices include and support a varied suite of mobile applications, or “apps,” enabling users to download and install many different applications to their user devices. The different applications, some of which include components configured to present content to users, may have different or custom online content interfaces and retrieval/delivery protocols. Additionally, the applications may request for and receive content (e.g., video content, audio content, and so on) from various different online, networked, and/or remote content sources, such as content delivery networks (CDNs), remote content servers, remote content storage sites, and so on.

Content is often delivered from remote content servers or associated edge caches to requesting devices (e.g., mobile or other user devices) over a network. Typically, a content provider or other network component utilizes cache controllers and associated algorithms to determine the content delivered to user devices that should be cached, such as content that is predicted to be popular, viral, and/or often requested by user devices. Therefore, when a user device requests delivery of a popular piece of content, the content provider, via the network edge cache, is able to quickly respond and deliver the requested content to the user device from the network edge cache that is proximate to the requesting user device.

Often, the delivery of content to a user device from a remote content source is less than optimal, especially when the user wishes to immediately consume the content. For example, the delivery of content from a remote server to a user device may be slow or ineffective due to limitations at the content source, in the delivery network, and so on.

### SUMMARY

Systems and methods for delivering content to user devices before the content is selected or requested (e.g. a pre-delivery of content) are described. In some embodiments, the system and methods receive, from a content server, information associated with content items available for retrieval from the content server and associated with one or more applications resident on a user device, select a subset of content items from the content items available for retrieval to deliver to the user device based on content usage information associated with the user device, and cause the user device to retrieve at least a portion of the selected subset of content items from the content server.

For example, the systems and methods may identify multiple content items associated with an application resident on the user device, the application capable of presenting the content items via an interface of the user device, determine a selection probability for each of the identified content items, the selection probability reflecting a likelihood of selection of a content items by a user of the user device, and retrieve content items that are assigned selection probabilities that satisfy a predetermined selection probability threshold.

Systems and methods for presenting information identifying pre-delivered content are described. In some embodiments, the systems and methods identify content items available for playback via an application resident on a user device, determine a retrieval location, such as a current storage location at a time of playback of the content items, for the identified content items available for playback via the application, and present a user interface that includes user-selectable elements associated with the content items available for playback via an application resident on a user device, the user-selectable elements displaying information identifying the content items and information identifying the retrieval location for the content items.

For example, the systems and methods may identify content items stored in a local cache of the user device, and display, along with description information for the content items, a display element that indicates the identified content items are stored in the local cache of the user device.

### BRIEF DESCRIPTION OF THE DRAWINGS

FIG. 1A is a block diagram illustrating a suitable computing environment.

FIG. 1B is a block diagram illustrating a flow of information between user equipment, a policy server, and a content server.

FIG. 2 is a block diagram illustrating an example application information file.

FIGS. 3A-3B are block diagrams illustrating example manifest files.

FIG. 4 is a block diagram illustrating components of a content delivery system.

FIG. 5 is a flow diagram illustrating a method for delivering content to a user device.

FIGS. 6A-6D are flow diagrams illustrating a method for managing the delivery of content to a user device.

FIGS. 7A-7B are flow diagrams illustrating a method for regulating the delivery of content to a user device.

FIG. 8 is a block diagram illustrating components of a content display system.

FIG. 9 is a flow diagram illustrating a method for presenting content available for playback at a user device.

FIG. 10 is a display diagram illustrating an example user interface that presents information identifying content available for playback.

### DETAILED DESCRIPTION

Systems and methods for delivering content to user devices before the content is selected or requested (e.g. a pre-delivery of content) are described. In some embodiments, the systems and methods includes a content delivery system that selects available content for pre-delivery to a user device based on a previous usage history of the user device and/or associated applications resident on the user device. The pre-delivery of content may include a delivery or transfer of content items from a remote content server to the user device before a user selects or identifies the content items for playback (or, before the user launches an application associated with the content items). The content delivery system, therefore, may deliver certain content items in advance and in anticipation of an application receiving a request from the user to playback the content items.

For example, a user has a smart phone that includes many different applications used by the user to select and consume online media delivered to the smart phone. The content delivery system monitors and tracks the usage of the applications and, at a later time, selects content to pre-deliver (e.g., transfer to the user device before the user or application initiates a selection of the content) to the user device for later viewing, in anticipation of the user requesting the content for presentation. Thus, when the user chooses a pre-delivered content file for playback, the application immediately accesses the content file that has been pre-delivered to the smart phone and begins playing the content file using a local copy of the file, providing the user with an immediate and reliable viewing, listening, or other multimedia experience for the selected content item.

In the following detailed description, reference is made to the accompanying drawings, which form a part of the description. The embodiments described in the detailed description, drawings, and claims are not meant to be limiting. Other embodiments may be utilized, and other changes may be made, without departing from the spirit or scope of the subject matter presented herein. It will be understood that the aspects of the present disclosure, as generally described herein and illustrated in the drawings, may be arranged, substituted, combined, separated, and designed in a wide variety of different configurations.

The technology can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term processor refers to one or more devices, circuits, and/or processing cores configured to process data, such as computer program instructions.

A detailed description of embodiments is provided below along with accompanying figures that illustrate the principles of the technology. The technology is described in connection with such embodiments, but the technology should not be limited to any embodiment. The scope of the technology is limited only by the claims and the technology encompasses numerous alternatives, modifications and equivalents. Numerous specific details are set forth in the following description in order to provide a thorough understanding of the technology. These details are provided for the purpose of illustration and the technology may be practiced according to the claims without some or all of these specific details. For the purpose of clarity, technical material that is known in the technical fields related to the technology has not been described in detail so that the technology is not unnecessarily obscured.

### Examples of the Network Environment

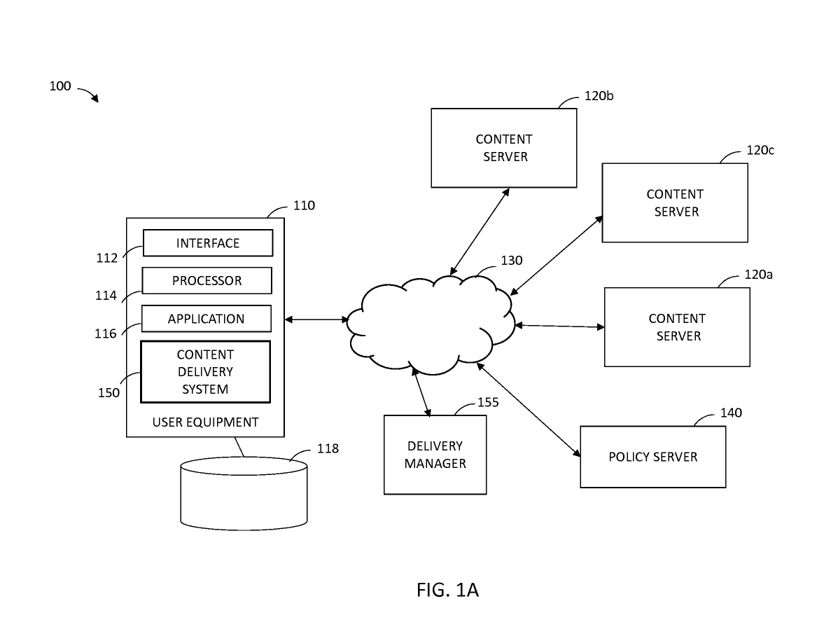

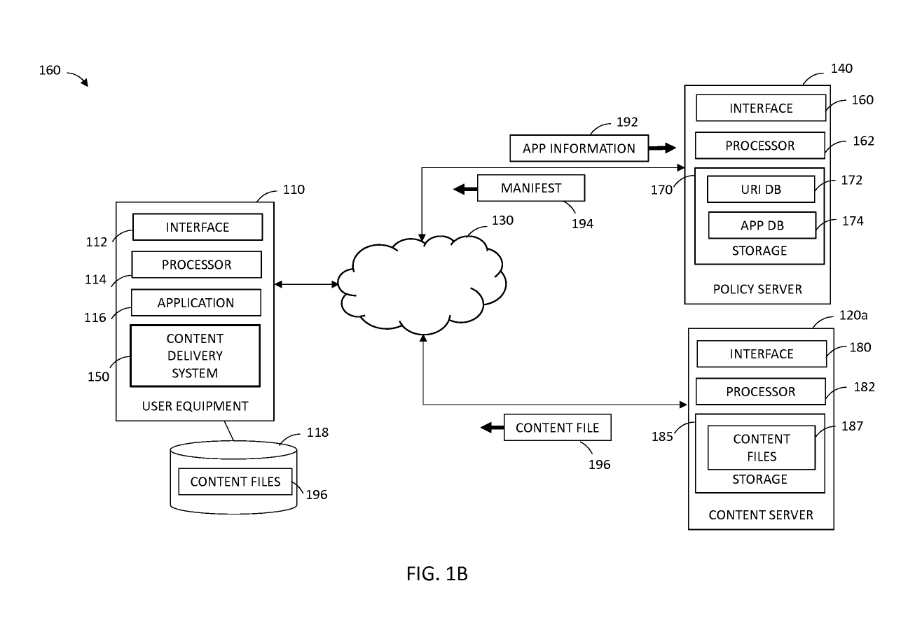

FIG. 1 is a block diagram illustrating a suitable network environment 100 for the delivery of content to user devices, such as the pre-delivery or anticipated delivery of content to user devices. The network environment 100 includes one or more user equipment or user devices 110, one or more content servers 120a-c, and a policy server 140 that communicate with one another over a data communication network 130.

Any of the machines, databases, or devices shown in FIG. 1 may be implemented in a general-purpose computer modified (e.g., configured or programmed) by software to be a special-purpose computer to perform the functions described herein for that machine, database, or device. Moreover, any two or more of the machines, databases, or devices illustrated in FIG. 1 may be combined into a single machine, and the functions described herein for any single machine, database, or device may be subdivided among multiple machines, databases, or devices.

The content servers 120a-c may provide a variety of different media and other content types, such as video content (e.g., movies, television shows, news programming, video clips), image content (e.g., image or picture slideshows), audio content (e.g., radio programming, music, podcasts), and so on. The content servers 120a-c may deliver, transfer, transport, and/or otherwise provide media files and other content to network edge caches (not shown), which may deliver, transfer, transport, and/or otherwise provide the content to requesting devices (e.g., user equipment 110a-c) via various media transfer protocols (e.g., Hypertext Transfer Protocol (HTTP), File Transfer Protocol (FTP), HTTP Live Streaming (HLS), HTTP Dynamic Streaming (HDS), HTTP Smooth Streaming (HSS), Dynamic Adaptive Streaming over HTTP (DASH), Real Time Streaming Protocol (RTSP), and so on).

The network 130 may be any network that enables communication between or among machines, databases, and devices. Accordingly, the network 130 may be a wide access network (WAN), wired network, a fiber network, a wireless network (e.g., a mobile or cellular network), a cellular or telecommunications network (e.g., WiFi, Global System for Mobile Communications (GSM), Universal Mobile Telecommunications System (UMTS), Long Term Evolution (LTE) network), or any suitable combination thereof. The network 130 may include one or more portions of a private network, a public network (e.g., the Internet), or any suitable combination thereof.

The user equipment 110 may include various types of user devices, such as mobile devices (e.g., laptops, smart phones, tablet computers, and so on), computing devices, set-top boxes, vehicle computing devices, gaming devices, and so on. The user equipment 110a-c may support and run various different operating systems, such as Microsoft® Windows®, Mac OS®, Google® Chrome®, Linux®, Unix®, or any other mobile operating system, including Symbian®, Palm®, Windows Mobile®, Google® Android®, Mobile Linux®, and so on.

The user equipment 110 may also support various components configured to request, receive, display, and/or present content to users associated with the user equipment 110. For example, the user equipment 110 may include applications 116, such as an app, browser, or other component that sends requests for content to content servers 120a-c and presents received content to the users via various display or presentation components, such as a user interface 112. The user equipment 110 may also include a processor 114 and local storage or caches 118, such as a local cache or data store that stores received content (e.g., pre-delivered or device cached content) and provides the stored content to the requesting applications 112. A local cache or storage 118 may be, for example, a storage or memory component contained by the user equipment 110, a detachable storage component that may be attached to the user equipment 110, a storage device associated with a local access network (LAN) that includes the user equipment 110, and/or other storage locations or devices that store media, files, and other data for the user equipment 110 (e.g., a storage location or device that provides storage and is accessible only by a certain or associated user equipment 110).

In some embodiments, the user equipment 110 includes a content delivery system 150 that includes components configured to select and cause delivery of certain content items, such as content items identified via information (e.g., a manifest file) provided by the policy server 140, which stores information associated with mobile applications, content sources, and available content, and provides a customized manifest file to the user equipment 110 that is based on the custom configuration of the applications resident on the user equipment 110. The content delivery system 150 may select a subset of the identified content items based on a variety of factors, such as previous usage of the user equipment 110 and/or the applications 116 resident on the user equipment 110, and cause the delivery of content items (or, portions of content items) of the selected subset to the user equipment 110. Further details regarding the components and processes performed by the content discovery system 150 are described herein.

The network environment 100 may include a delivery manager 155, which directs or otherwise manages the delivery of content between devices, such as from the content servers 120a-c to the user equipment 110, from the user equipment 110 to the content servers 120a-c, between user equipment, between content servers (e.g., from content server 120b to content server 120c), and so on. The delivery manager 155 may, when instructed, track, store, and/or provide information associated with various network delivery policies and/or protocols utilized during the delivery of content over the network 130. Although the delivery manager 155 is depicted as being separate from the content servers 120a-c, any of the content servers 120a-c and/or the policy server 140 may include some or all components of the delivery manager 155. Additionally, in some configurations, the delivery manager 155 and/or the content servers 120a-c may include some or all components of the policy server 140

In some embodiments, the delivery manager 155 directs or manages the delivery of content via a delivery policy that utilizes or uses surplus network bandwidth or surplus network capacity. A surplus of network bandwidth or network capacity may be network bandwidth or network capacity that is determined to be available (e.g., idle or free) in a network in view of the total capacity of the network and/or and the total usage of the network. In some embodiments, a network provider determines the amount of surplus network capacity available in a network in view of the total capacity of the network and/or and the total usage of the network. The surplus network capacity may be determined statically or dynamically, and, therefore, a determined surplus network capacity for a network may vary substantially and/or randomly over time (e.g., during peak use periods), for long or short time scales, and/or between one service provider to another.

The surplus capacity, therefore, may be the free bandwidth or capacity between an actual and/or current usage of the bandwidth a total capacity (or, a predetermined percentage of the total capacity). Therefore, the delivery manager 155 may direct or manage the delivery of content between content providers 120a-c, network edge caches (not shown), and user equipment 110 over various selected delivery policies or protocols that utilize free, available, idle, or otherwise surplus bandwidths or capacities of networks, such as paths or protocols that deliver data over currently underused networks that would not otherwise be in use, and/or without substantially impacting or altering the transport performance associated with other data traffic sharing the network.

Further details regarding the delivery of content using surplus network capacity may be found in commonly-assigned U.S. Pat. No. 7,500,010, issued on Mar. 3, 2009, entitled ADAPTIVE FILE DELIVERY SYSTEM AND METHOD, U.S. Pat. No. 8,589,585, issued on Nov. 19, 2013, entitled ADAPTIVE FILE DELIVERY SYSTEM AND METHOD, U.S. Published Patent Application No. 2010/0198943, filed on Apr. 15, 2010, entitled SYSTEM AND METHOD FOR PROGRESSIVE DOWNLOAD USING SURPLUS NETWORK. CAPACITY, and U.S. Published Patent Application No. 2013/0124679, filed on Jan. 3, 2013, entitled SYSTEM AND METHOD FOR PROGRESSIVE DOWNLOAD WITH MINIMAL PLAY LATENCY, all of which are hereby incorporated by reference in their entirety.

FIG. 1B is a block diagram 160 illustrating a flow of information between the user equipment 110, the policy server 140, and the content server 120a, during the discovery of content sources and/or the identification, selection, and delivery of content to the user equipment 110.

The user equipment 110 collects and stores a local application inventory list and application usage data, and provides or transmits application information 192 to the policy server 140, information identifying one or more applications resident on the user equipment 110. For example, the user equipment 110 may transmit the application information file 192, which includes information identifying applications 116 resident on the user equipment 110 and application usage information identifying historical usage of the applications resident on the user equipment 110.

The user equipment 110 may periodically inventory the applications 116 currently installed on the user equipment 110. For example, the user equipment 110 may query the operating system (OS) of the user equipment 110 or an application registration service employed by the user equipment 110 to obtain a list of unique identifiers for the applications installed and resident on the user equipment 110. In some cases, the user equipment 110 may generate the list of unique identifiers by inspecting the storage 118 of the user equipment 110, such as by searching for executable files having known names.

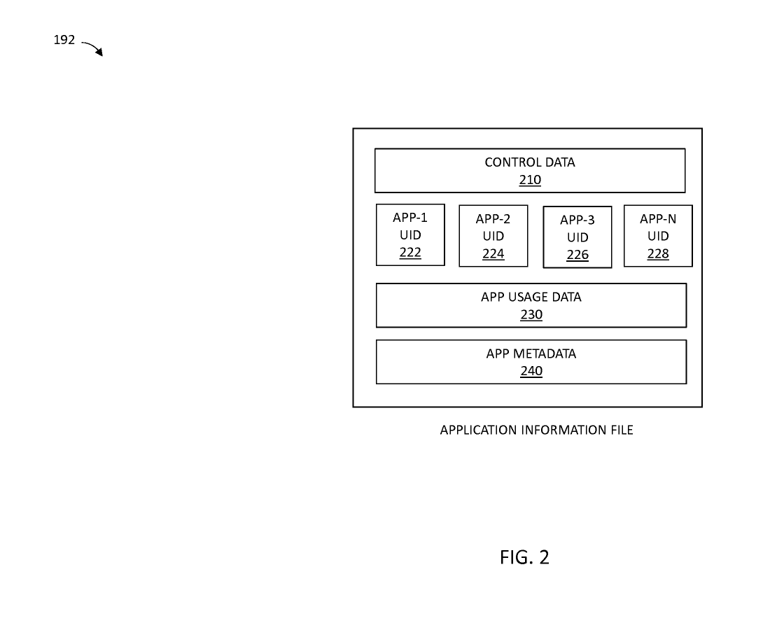

FIG. 2 is a block diagram illustrating an example application information file 192. The user equipment 110 may generate an application information file 192 that includes application control data 210, application unique identifiers 222, 224, 226, and 228 for the applications 116 resident on the user equipment 110, and application metadata 240 associated with the resident applications 116, such as the dates of installation, application sizes, application versions, application build data, and so on.

The user equipment 110 may also add application usage data 230 to the application information file 192. For example, the user equipment 110 may inspect a local application usage database, and append the application usage data 230 to the application inventory record and corresponding unique application identifiers 222, 224, 226, 228. The application usage data 230 may include, for each application 222, 224, 226, 228, the date of last use, the number of application launches, the network delivered content volume, and/or the number of network delivered content files. The application usage data 230 may also include the type of network and operator used to deliver the content to the user equipment 110.

For example, the application usage information or data 230 may reflect various different application usage patterns, such as a list of applications, ordered from most used to least used applications, a list of all applications used within a certain or predetermined time period or time window (e.g., the previous 24 hours, the previous week, the previous month, and so on), a list of applications recently used, a list of applications used over a certain threshold number of instances within a certain time period, and/or other usage patterns or usage trends.

Referring back to FIG. 1B, the policy server 140 receives the application information files 192 and stores the files 192 in the application information database 174. In some cases, the collection process may be spread out over time, as the policy server 140 receives files or reports 192 from different clients in a serial fashion. For example, the policy server 140 may initially collect files 192, and thereafter once every N days (e.g., 30 days) after starting with no prior recorded operating history. Periodically, a server administer may launch the user interface 160 to examine the collected records stored in the local application information database 174.

By examining the collected application information files 192, the policy server 140, via a running algorithm or via an administrator, may determine a relative popularity or other patterns associated with a particular or certain application in a population of reporting clients. In some cases, the algorithm or administrator may focus on certain types of groups of applications, such as applications known to heavily use the network 130 for media file delivery, the most popular applications, the applications known to consume the greatest amount of content, and/or other similar criteria or combinations of criteria.

In some embodiments, the algorithm or administrator may distinguish and select distinct groups of applications for reporting clients sharing certain applications, such as applications requiring or requesting content access authorization from users of the applications.

The user equipment 110 also receives a content manifest file 194, including universal record indicator (URI) lists from the policy server 140, which correspond to content sources associated with the applications 116 resident on the user equipment 110. Further, the user equipment 110 may retrieve content from the content server 120a and store the content in local storage 118, a portion of which may be include a content file device cache.

In some embodiments, the user equipment 110, via the content discovery system 150, accesses and intercepts requests for content originating from the resident applications 116, determines whether a content request includes a known URI (uniform resource identifier) and unique content ID, and, if known, provides the requested content from the device cache 118, when available (and, optionally, records the use of the application).

The policy server 140, which includes an interface 160 and processor 162, collects and stores in a database 170 the received application information 192 (e.g., application identification and usage reports or lists). The policy server 140 may also include an administrator user interface that enables a server administrator to view the list of applications in the application database 174, such as in an order of the number of reporting clients, and enables the server administrator to construct a URI database 172 that contains records including the application identifiers, one or more URIs specifying content available to the applications, content-request syntax templates, and other information associated with the content sources available to the applications.

The policy server 140 provides the content manifest file 194, which may include URIs associated with available content, to the content discovery system 150 located in the user equipment 110. The manifest file 194 may include, for each application identifying in the application information file 192, corresponding content URIs and application identifiers, among other information.

For each selected application, an administrator manually configures the business logic that may be used by an automated server process to periodically receive updates of the content items available from one or more content feeds associated with the application. A content feed may be any source of online content available to multiple users for download or delivery. The administrator may determine how the application determines and retrieves new available content, such as by obtaining implementation details from the application developer, by examining packet traffic to and from the application, and so on.

In some cases, applications have distinct and custom means for content awareness and retrieval, and their associated business logic may be specific to the application, content type, and/or version. In some cases, the content awareness/retrieval process of the application may follow established standards, such as Rich Site Summary (RSS) or ATOM (IETF RFC 4287).

Once the feed business logic is configured, the policy server 140, via the administrator, activates a process to generate (or, at times, to update) the content manifest files 194, which are specific and configured for each application. In generating the manifest files 194, the policy server 140 communicates with the content servers 120a-c associated with the content feeds, obtaining a current list of content item URIs for content available to the applications. The policy server 140, in some cases, triggers communication with the content servers 120a-c by periodic requests (e.g., using a synchronous timer once per hour), by pushing requests, by manual requests, by automated requests, and so on.

Often, a list of available content items received from the content servers 120a-c is large, and the policy server 140 may apply rules or thresholds to limit the manifest file 194 to a maximum size limit, a category of content, a type of content, to predetermined file sizes, and so on. Likewise, the content delivery system 150 may apply rules or thresholds to limit the number of type of content items that are identified within the manifest file 194. In addition, the policy server 140 may apply compression techniques to compress the manifest file (e.g., via lossless file compression techniques) in order to reduce the transport size of the manifest file 194.

Once the manifest file 194 has been generated, the policy server 140 communicates the file to the user equipment 110, such as via serial or broadcast/multicast communications. In some cases, the delivery of the manifest file 194 may be triggered by a client request or by a server notification that a new manifest file 194 is available. In other cases, the user equipment 110 communicates a current manifest file 194 status known to the user equipment 110, and if the policy server 140 determines that no update is available, the policy server 140 does not provide a manifest file 194 in response to a request (e.g., a no-change notification may be provided).

As described herein, the manifest file 194 provides information to the content delivery system 150 that identifies the content files available to user applications installed on the specific user equipment 110 that includes the content delivery system 150, as well as a content request template that enables the content delivery system 150 to determine when content requested by the applications 116 resident on the user equipment 110 may have been previously cached (or is otherwise deemed redundant or unneeded) by the content delivery system 150 to the mobile device 110.

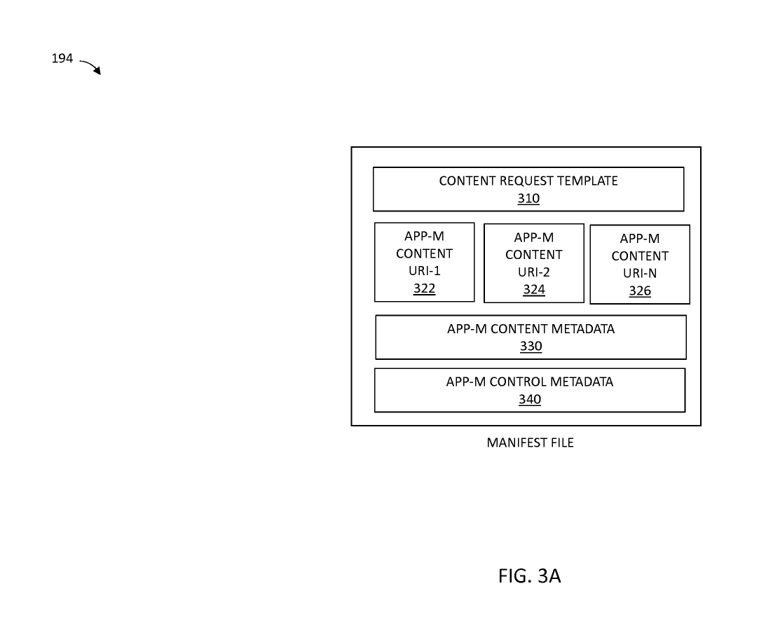

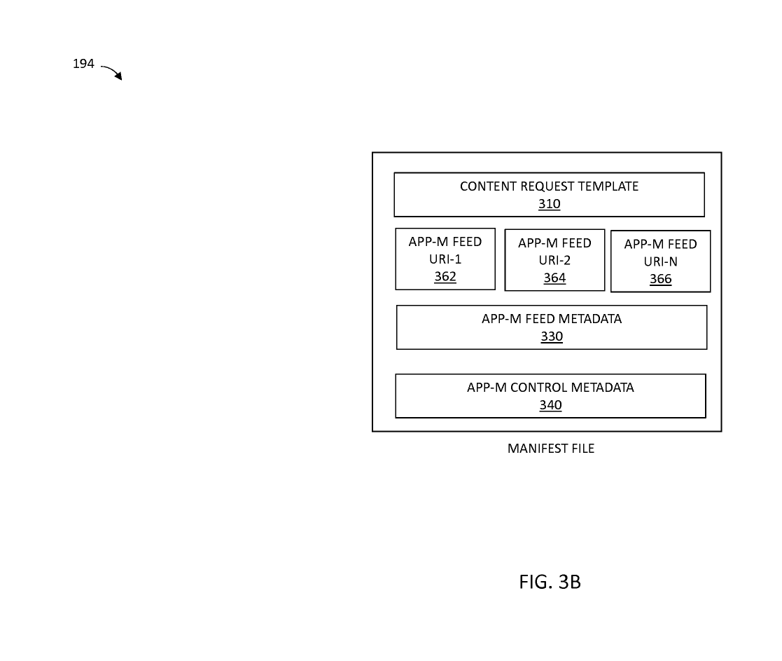

FIGS. 3A-3B are block diagrams illustrating example manifest files 194. Referring to FIG. 3A, the manifest file 194 includes a set of data records (one per application) with various sub fields for specifying what current content is available to the app from the remote content servers 120a-c. The manifest file 194 also includes the content request template 310, which specifies, for example, a searchable request string pattern used by applications communicating with the remote content servers 120a-c.

In some embodiments, the content request template 310 is the protocol (e.g. HTTP) command (with wild-card characters indicating optional or non-static portions of the command) used to request a content file download to the application, such as for video playback while downloading (e.g., streaming media playback). In some embodiments, the request string pattern may include a sequence of request/response pairs between client and content server, such as in cases where a hierarchy of content server message exchanges is required to retrieve requested content.

In some embodiments, the content delivery system 150 may utilize the content request template 310 to form content file request commands, in order to pre-cache content onto the user equipment 110, and/or to parse outgoing content request commands from applications running on the user equipment, and identify unique resource identifiers for the requested content. For example, a content request template 310 may be applied to the payloads of HTTP GET requests to parse commands that may contain strings of the generic format:

```
{
  “host”: “example.com”
  “path”: “[?&]video_id=([\hat{ }&]*)”
} .
```

In this example, the regular expression may be applied to the path element of an outgoing HTTP request for the particular host. The unique video id value is matched and extracted, and the content delivery system 150 uses it to determine whether the requested content file is already, or at least partially, pre-cached locally on the user equipment 118.

The manifest file 194 also includes locator record specifications 322, 324, 326 for content that is currently available for download by the application, as well as content metadata 330, such as content file size, content category keywords, content posting time, content text description or images, video/audio resolution, content popularity, file format and other information intended to help distinguish which content should be pre-cached to the user equipment 110, and/or control data 340, such as server software version information, manifest creation time, expected next manifest creation time, and/or other information intended to assist in managing the manifest distribution process.

In some embodiments, the content delivery system 150 utilizes the content uniform resource indicators 322, 324, 326 to identify and pre-cache content files on to the user equipment 110. For example, a list of content uniform resource indicators may be formatted in JSON language syntax:

```
[
  “item”: { “mg”: http://example.com/content1/videoplayback?video_id=55455 }
  “item”: { “mg”: http://example.com/content2/videoplayback?video_id=99677 }
  ...
]
```

The content delivery system 150 may use the content request template 310 to extract one or more video unique identifiers from the list (e.g. 55455, 99677, etc.) and create a database of identifiers corresponding to content files. The content delivery system 150 pre-caches the selected content files, using the URL's in the list to retrieve them with HTTP GET commands. The content identifier database may also be used during content request interception to determine whether the requested content is pre-cached or not cached.

Referring to FIG. 3B, in some embodiments, the manifest file 194 may specify a feed directory or folder where content may be available, rather than the actual individual file items associated with a feed directory or folder. For example, the data records 362, 364, 366 in the manifest file 194 may include information identifying the content feeds associated with content available to the application. Thus, the content delivery system 150, using the manifest file 194 of FIG. 3B, may query a feed (e.g., via a directory command) to discover and process available content items.

For example, a list of content feeds may be retrieved from the manifest formatted in JSON language syntax:

```
{
  “url”: “http://example.com/feed”
  “type”: “text/json”
  “urlJSONPath”: “$.videoItems[:].url”
} .
```

In this example, the content delivery system 150 retrieves the feed URL (e.g. http://example.com/feed), returning for example:

```
{
  “videoItems”: [
    { “url”: “http://example.com/content2/videoplayback?video_id=55455” },
    { “url”: “http://example.com/content2/videoplayback?video_id=99677” },
    { “url”: “http://example.com/content2/videoplayback?video_id=13324” }
  ]
} .
```

The retrieved feed list may then be parsed via the “urlJSONPath” search specification to generate a JSON item list similar to the lists described herein.
Although the JSON language is illustrated in these examples, other equivalent alternatives could be used, including XML (with XPath), YAML, or Google Protocol Buffers.

In some embodiments, the policy server 140 may present a user of user equipment 110 with a user interface for manually creating, editing or appending to the content manifest file 194. The policy server 140 may enable the user to create custom feeds or content specifications and request templates for their specific device 110, among other customizations. Further details regarding the discovery of content may be found in commonly-assigned and co-pending U.S. patent application Ser. No. 14/335,826, filed on Jul. 18, 2014, entitled CONTENT SOURCE DISCOVERY, which is hereby incorporated by reference in its entirety.

The content server 120a, which may include an interface 180, a processor 182, and many content files 187 located in storage 185 of the content server 120a, provides requested content files 196 to the user equipment 110. The content delivery system 150, therefore, may locally cache the received content files 196 in the local storage or cache 118 of the user equipment 110, in order to locally server or device cache content to the applications 116 when the applications 116 request the content from the content server 120a.

### Examples of Delivering Content to User Devices

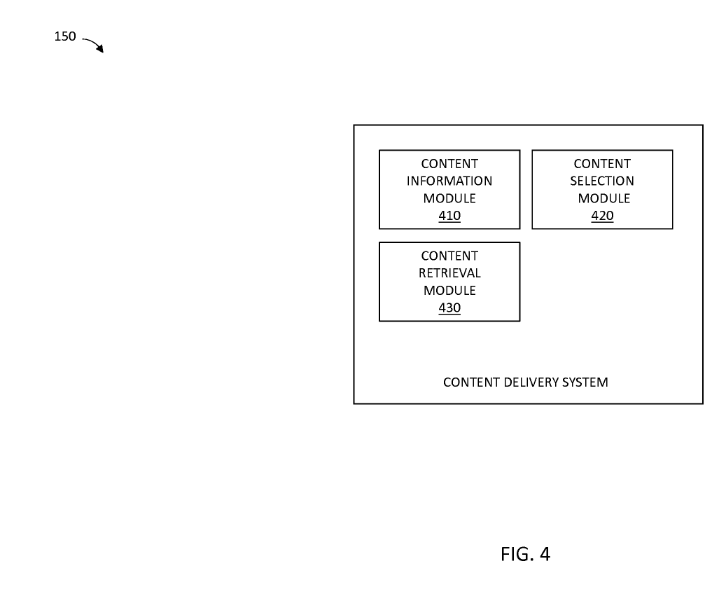

As described herein, in some embodiments, the content delivery system 150 enables a mobile device or user device 110 to pre-deliver or otherwise retrieve and store content into device storage for various different applications 116 resident on the mobile device 110, such as in anticipation of serving the content to the applications 116 when the applications request the content from the content servers 120a-c (e.g., via a request received from a user associated with the user device 110). FIG. 4 is a block diagram illustrating the components of the content delivery system 150.

The content discovery system 150 may include one or more modules and/or components to perform one or more operations of the content delivery system 150. The modules may be hardware, software, or a combination of hardware and software, and may be executed by one or more processors. For example, the content delivery system 150 may include a content information module 410, a content selection module 420, and a content retrieval module 430.

In some embodiments, the content information module 410 is configured and/or programmed to receive, from the server, information associated with content items available for retrieval from a content server and/or associated with the identified one or more applications. For example, the content information module 410 may transmit information identifying the one or more applications resident on the user device (e.g., the application information file 192) to the policy server 140, and receive information associated with content items, such as the content manifest file 194 from the policy server 140. As described herein, the content manifest file, or manifest file 194, may include a content request template and one or more uniform resource identifiers associated with content or content feeds located at the content server and available for retrieval by the user device.

In some embodiments, the content selection module 420 is configured and/or programmed to select a subset of content items, from the content items available for retrieval, to deliver to the user device based on content usage information associated with the user device. The content selection module 420 may select a certain number of content items from a large set of available content items, based on information identifying a previous usage of the applications or content at the user device 110.

For example, the content selection module 420 may monitor or access the usage behavior, such as previous usage behavior of a user consuming content via the applications installed on the user device 110. The usage behavior may include whether a content item is or was pre-delivered, whether the content item is or was consumed (e.g., listened to, played, experienced, watched, and so on), how frequently the user uses or has used the applications, which networks are used to deliver the content, user preference configurations, and so on. Based on the previous usage behavior, the content selection module 420 may select, for pre-delivery, a subset of available content that the user is likely to select to watch at a later time.

In some embodiments, the content selection module 420 may determine a viewing probability for each of the content items available for retrieval that is based on the content usage information that reflects an over delivery ratio for content items, and select content items assigned a determined viewing probability that satisfies a threshold probability. For example, the content selection module 420 may determine a viewing probability for each of the content items available for retrieval that is based on content usage information that reflects an over delivery ratio for content items, rank the content items based on the determined viewing probabilities, and select a subset or all of content items based on the ranking of the content items.

In some embodiments, the content selection module 420 selects the subset of content items based on a delivery method associated with delivery of the content items to the user device. For example, the content selection module 420 may select certain content items associated with a certain content provider and/or associated with a certain delivery network or data transfer method.

In some embodiments, the content retrieval module 430 is configured and/or programmed to cause the user device to retrieve at least a portion of the selected subset of content items. For example, the content retrieval module 430 may retrieve content items associated with one of the one or more uniform resource identifiers retrieved from the manifest file 194 and via a content retrieval protocol identified by the content request template 310 in the manifest file 194. As described herein, the content request template 310 may define a content retrieval protocol for the content source or server 120a-c.

For example, the content retrieval module 430 receives the manifest file 194 originally transmitted by the policy server 140, and determines which content items are to be pre-delivered, or pre-cached fully or in part to the mobile device 110, using the content URIs 322, 324, 326 in the manifest file 194. For example, the content retrieval module 430 may determine content to be pre-delivered to be some or all content that is recent or new created or posted, via previous usage or download history, and so on. Using the received manifest file 194, the content retrieval module 430 selects certain content items, and retrieves the content item using the URI to request the delivery (e.g., via surplus capacity over the network 130).

In some embodiments, the content retrieval module 430 causes the user device 110 to retrieve a certain portion of the content items based on the viewing probabilities assigned to the content items. For example, the content retrieval module 430 may cause the user device 110 to retrieve complete copies of content items that are assigned high viewing probabilities, and cause the user device 110 retrieve partial copies (e.g., first portions) of content items that are assigned lower viewing priorities. In such cases, the content retrieval module 430 may cause delivery of the remaining portions of the content after the application makes an initial content selection for playback.

In some embodiments, the content retrieval module 430 may utilize token-based rules or algorithms to regulate the content delivered to a user device, in order to regulate the number of content items delivered (e.g., pre-delivered) to the user device 110. For example, the content retrieval module 430 may determine a number of tokens that are associated with a user of the user device 110, and cause the user device to retrieve a portion of the selected subset of content items based on the determined number of tokens associated with the user.

In some embodiments, the content retrieval module 430 may monitor and/or manage a local storage capacity associated with the user device 110, in order to maintain content items likely to be consumed in the local storage capacity (which may have a limited capacity). For example, the content retrieval module 430 may determine that a current capacity of local storage for the user device 110 is not sufficient to store the at least a portion of the selected subset of content items, calculate a retention score for content items within the local storage (e.g., a score based on an age and/or viewing probability assigned to the content item), identify one or more content items currently stored within the local storage having a retention score that is lower than a threshold retention score, and removes the identified one or more content items from the local storage.

Thus, the content delivery system 150 may select content items likely to be consumed by a user at the user device 110 based on a previous usage history for the user and/or the user device 110, retrieve the selected content items (or, portions of the content items) based on a token-based process, and consistently and/or continuously monitor and manage a local storage capacity of the user device 110 to provide the user device 110 with the content items most likely to be selected by a user at any given time, among other things.

For example, the content delivery system 150 may be part of a user client installed on the user device 110, causing the user device 110 (e.g., a smart phone or tablet) to classify the content items into one or more content classifiers for the content items, calculate a predicted viewing probability for each of the content items based on the content classifiers and historical viewing statistics associated with the classifiers, rank the content items according to the predicted viewing probabilities, cache a selected volume or number of the highest ranked content items to the user device 110, modify usage statistics of the corresponding classifiers based on the caching and based on whether the content is or is not consumed by the user.

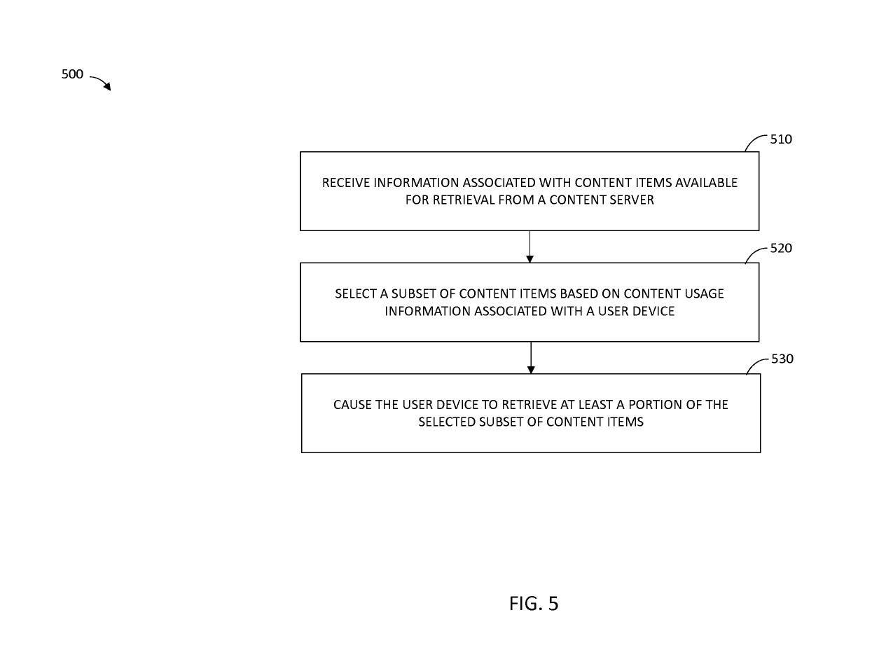

As described herein, the content delivery system 150 may perform various different methods, processes, and/or algorithms when delivering content to the user device 110. FIG. 5 is a flow diagram illustrating a method 500 for delivering content to a user device. The method 500 may be performed by the content delivery system 150 and, accordingly, is described herein merely by way of reference thereto. It will be appreciated that the method 500 may be performed on any suitable hardware.

In operation 510, the content delivery system 150 receives, from a content server, information associated with content items available for retrieval from the content server and associated with one or more applications resident on a user device. For example, the content information module 410 may transmit information identifying the one or more applications resident on the user device (e.g., the application information file 192) to the content server, and receive information associated with content items, such as the content manifest file 194 from the policy server 140. As described herein, the content manifest file, or manifest file 194, may include a content request template and one or more uniform resource identifiers associated with content or content feeds located at the content server and available for retrieval by the user device.

In operation 520, the content delivery system 150 selects a subset of content items from the content items available for retrieval to deliver to the user device based on content usage information associated with the user device. For example, the content selection module 420 may select a certain number of content items from a large set of available content items, based on information identifying a previous usage of the applications or content at the user device 110.

In operation 530, the content delivery system 150 causes the user device to retrieve at least a portion of the selected subset of content items from the content server. For example, the content retrieval module 430 may retrieve content items associated with one of the one or more uniform resource identifiers retrieved from the manifest file 194 and via a content retrieval protocol identified by the content request template 310 in the manifest file 194.

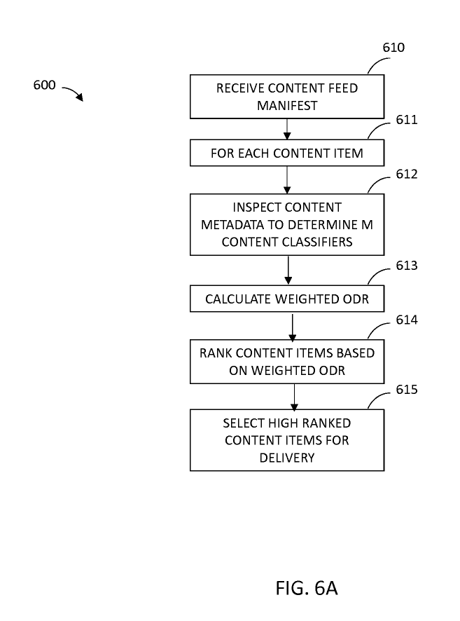

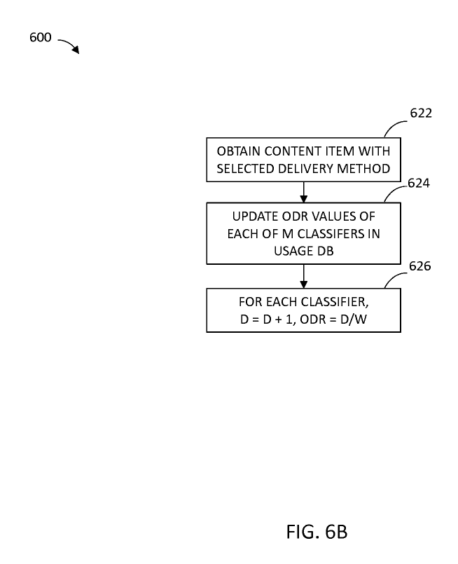

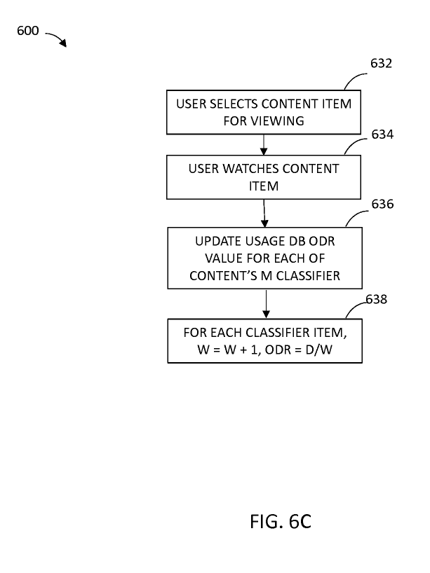

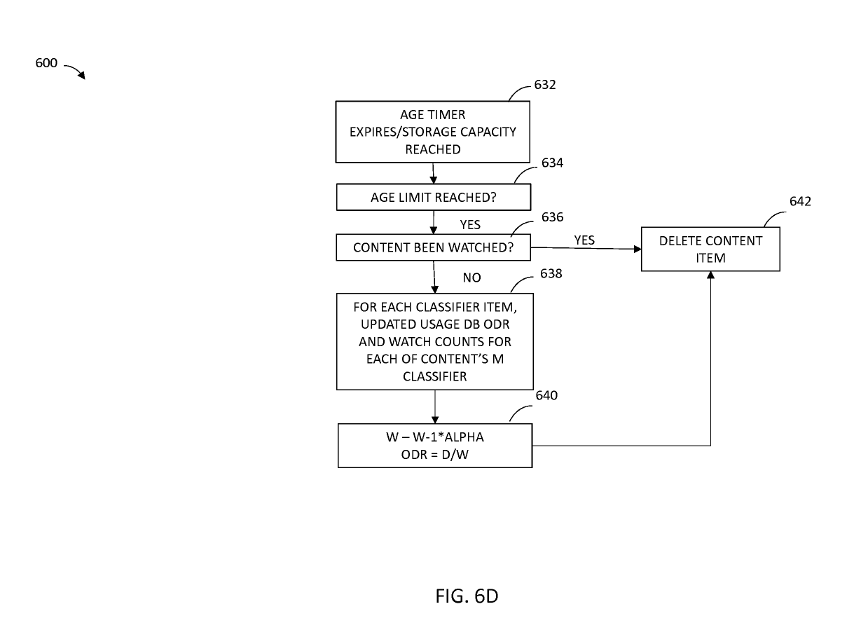

FIGS. 6A-6D are flow diagrams illustrating a method 600 for managing the delivery of content to a user device. The method 600 may be performed by the content delivery system 150 and, accordingly, is described herein merely by way of reference thereto. It will be appreciated that the method 600 may be performed on any suitable hardware.

Referring to FIG. 6A, the content delivery system 150, in operation 610, receives the content manifest file 194, such as a content manifest file 194 that includes a list of available content for one or more selected or specific applications. In operation 611, the content delivery system 150 extracts content metadata from the content manifest file 194 (or from links within the manifest file 194), such as content category keywords, content creator IDs, content poster IDs, content recommender IDs, file lengths, content runtimes, content posting times, content text descriptions or images, video/audio resolutions, content popularities, content expected lifetimes, file formats, and other information useful for classification of the content.

In operation 612, the content delivery system 150 determines one or more (“M”) distinct or hierarchical classifications for the content items. For example, each content item is associated with a plurality of content classifications (e.g., sports, science, top-news, world, politics, television series, and so on). A classification may refer to a category, class, or topic, or may refer to a more general set of metadata items (e.g., a classification may be a unique set of one or more metadata items or classifiers) used to distinguish different content items from each other. For example, a video story “scientists announce baseball design that will double home-runs” might be have a classification that includes the following classifiers: top-news, science, sports, video-content, and short-form runtime, or be assigned to the categories of “baseball” and “physics.”

In operation 613, the content delivery system 150 calculates or determines a weighted over delivery ratio, or ODR, for the content items. The content delivery system 150 may associated a usage statistic to each of the classifiers or categories, where the usage statistic corresponds to a predicted probability that a user will consume content associated with that classification. The ODR is a dimensionless ratio of the delivered content D to the watched content W, or

ODR=D/W, where D is the number of content items that are pre-delivered to user device 110, and W is the number of content items that are consumed at the user device 110 (e.g., by a user associated with the user device 110).

For example, when 10 (ten) content items having a certain classification are delivered to a user device 110, and 2 (two) content items are watched, then the ODR for the classification is 5 (five). In some cases, the D and the W may be quantified with other metrics, such as content file length (e.g., bytes), playback run time (e.g., minutes), and so on. Thus, the ODR=1 for a classification when all pre-delivered content items having a certain classification are viewed, and the ODR>1 when some of the pre-delivered content items are not viewed. Also, the ODR<1 when certain content items are watched multiple times, or in some cases the ODR may be set to 1 when the calculated ODR is less than 1.

Many content items are associated with multiple classifiers (or, categories), and the content delivery system 150 calculates the weighted ODR, which reflects the multiple classifiers, as follows:

Weighted ODR=SUM (ODRi*Wi/SUM(Wk)), where the outer SUMO runs over the set of classifiers for content items having multiple classifiers, ODRi is the i'th historical over delivery ratio statistic, Wi is the historical watched statistics, for the i'th classifier in the set of classifers, and SUM(Wk) is the total watch count for all the classifiers associated with the content item.

As described herein, the content delivery system 150 may associate the content items with multiple content classifiers, where some of the classifiers have a high ODR that is based on usage behavior for content items having the classifiers. Thus, when comparing the weighted ODR values between content items with heterogeneous sets of classifiers, the content delivery system 150 maintains a rough equivalence between the number of classifiers associated with the content items and the resulting weighted ODR values. For example. the content delivery system 150 maintains the classifier equivalence by calculating the weighted ODR using a limited maximum number of classifiers, or a certain limited set of classifiers chosen to meet certain criteria, such as most popular category keywords. Following the example, if a content item could be associated with 15 classifiers, the content delivery system 150 may only use the top three classifiers (e.g., ranked by their ODR values) to calculate the weighted ODR, ignoring the other classifiers. Other content items having three classifiers (e.g., determined using relatively limited available metadata) could then be fairly compared based on their weighted ODR values.

In some embodiments, the content delivery system 150 rescales the weighted ODR values to the interval [0,1], which may correspond to or reflect an expected viewing probability, e.g., that the content item will be selected by a user and watched (or otherwise consumed) after the at least some of the content item has been pre-delivered to the user device 110. In resealing, lower weighted ODR values (e.g., combinations of content classifications where the user has historically tended to watch the pre-delivered content) would therefore have corresponding higher viewing probability scores. For example, an ODR of 1 may be resealed to a viewing probability of 100%, and an ODR of 3 may be resealed to a viewing probability of 60%. Of course, the content delivery system 150 may utilize other scoring metrics and scales when assigning a viewing probability or likelihood determination to a classifier, classification, and/or content item.

In operation 614, the content delivery system 150 ranks the content items based on the calculated weighted ODRs, or other probability scores, and, in operation 615, selects some or all of the highest ranked content items for pre-delivery to the user device 110, such as using various selection algorithms or processes described herein. In some cases, the content delivery system 150 may occasionally select lower ranked or unranked content items for pre-delivery, in order to explore potential interests of a user who might be unaware of particular content and classifications, among other things.

Referring to FIG. 6B, in operation 622, the content delivery system 150 causes retrieval of the selected content items using a selected or determined delivery method or protocol, such as the protocols described herein. In some embodiments, the content delivery system 150 may relate the pre-caching strategy of content items to the viewing probabilities assigned to the content items. For example, if the content is more likely to be watched (e.g., a viewing probability near to 1), then the content delivery system 150 may cause a complete delivery of the content item, and if the viewing probability is less than a threshold value, then the content delivery system 150 may cause a partial delivery (e.g., 25% of the total file length, or a fraction determined as a function of the viewing probability) of the content item. The content delivery system 150 may then cause the remainder of the content item to be delivered after the user requests playback of the partially delivered content item, such as during presentation of the content item to the user.

In operation 624, the content delivery system 150 updates the ODR values stored in a usage database for each of the M classifiers assigned to content items based on the delivery of content items associated with the classifiers. In operation 626, the content delivery system 150 calculates, for each classifier, an adjusted ODR. For example, for a given classification, if 10 content items have been delivered, and 5 have been watched (a current ODR of 2) and a new content item is delivered, the new and adjusted ODR value is equal to (D+1)/W or (10+1)/5=2.2. In other words, the new content item delivery increases the ODR values for each of the classifiers.

At any time after content has been delivered and cached, the user may select a content item and play the file. Referring to FIG. 6C, in operation 632, a user selects a content item for viewing, and, in operation 634, watches at least a configurable completion percentage threshold of the total file. In response to the selection and/or viewing of the content item, the content delivery system 150, in operation 636, updates the usage database with an adjusted ODR value for the classifiers associated with the viewed content item.

In some embodiments, the content delivery system 150 receives a message, indication or notification that the content item was consumed from the application that plays the content item, via a content player module called by the application, by the host operating system, and so on.

In some embodiments, the content delivery system 150 may consider the consumption of content that has not been pre-delivered when adjusting the usage statistics for classifiers associated with the consumed content items. For example, using an application, a user selects a video that is not available in the local cache and is therefore delivered from a remote content server after selection. By monitoring then usage of content that is not pre-delivered, the content delivery system 150 may adjust or create ODR values for classifiers associated with the new content that reflect the interests of the user.

In operation 638, the content delivery system 150 retrieves the classifier list for the content item being played, and for each classifier associated with the content item, increments the watch count by 1 and recalculates the ODR value for the classifier. For example, for a given classification, if 10 content items have been delivered, and 5 have been watched (a current ODR of 2) and a new content item is watched, the new and adjusted ODR value is equal to D/(W+1) or 10/(5+1)=1.6. In other words, the consumption decreases the ODR values for each of the classifiers.

In some embodiments, the content delivery system 150 may adjust or modify the ODR statistics in a variety of ways. For example, the content delivery system 150 may access rating information provided by the user for certain viewed content items, and adjust ODR values associated with the content based on the ratings (e.g., a high rating of 4 stars may be equal to a watch count of 2, whereas a low rating of 1 star may be equal to a watch count of −1).

In some embodiments, the content delivery system 150 may remove content that is cached locally on the user device 110 for a variety of reasons. For example, content may be removed to make room for more recent content or newly available content having a higher viewing probability, due to change in content status, for new or current user preferences, and so on. The content delivery system 150, therefore, may manage of content that has never been viewed differently than content that the user has selected and played at some point after it was delivered and cached, by continuously adjusting classification preferences for a user and/or user device 110.

Referring to FIG. 6D, in operation 632, the content delivery system 150 access or receives a notification of an expiring content aging timer, a storage capacity limit being reach, or other events or triggers associated with modifying or managing a local storage of content items. In operation 634, for each content item in local storage, the content delivery system determines whether an age limit has been reached, in operation 636, determines whether the content item has been watched or otherwise consumed. When the content item has been watched and has expired, the content delivery system 150, in operation 642, deletes or removes the content item from the local storage.

When the content item has expired, but the content item has not been watched, the content delivery system 150, in operation 638, updates the usage statistics for the content item in the usage database. For example, the content delivery system 150, in operation 640, may adjust the watch count by calculated an adjusted W for the classifier as W−W*ALPHA, where the decrement factor ALPHA may depend on whether the content was entirely or partially cached and/or consumed, the type of network used to deliver the content, the elapsed delivery time, the size of content file, network operator preferences, the content type, the content priority, and so on. Once the usage statistics are adjusted, the content delivery system 150, in operation 642, deletes or removes the content item from the local storage.

Of course, the content delivery system 150 may consider other metrics when assigning viewing probabilities to classifiers and/or content items. Examples of other metrics include the user behavior of whether content after viewing is recommended to one or more friends, how much of a video is watched, where and when a video is consumed, whether a commercial goods purchase is attributed to a video view, the elapsed time since the last similar video was consumed, and so on.

For example, as described herein, in some embodiments, the content delivery system 150 selects content items for pre-delivery based on a delivery method associated with delivery of the content items to the user device 110. For example, the content delivery system 150 may weigh a tradeoff of pre-delivering content items to the user device 110 versus the cost or impact of the pre-delivery has on the network and users (e.g., a user benefits from pre-delivery when the content is instantly available for consumption, but loses local storage space of the user device 110 to store the pre-delivered content, or a network may use limited resources during the pre-delivery process, providing fewer resources for other users at the same time).

An arbitrary content item may be modeled as a set of features. A feature is an individual measurable heuristic property of an object or phenomenon being observed. Features are typically numeric, but structural features such as strings or graphs may also be used. Examples of features for a content item include the category or genre of a content item, the length of a content item such as the length of time for a song or movie, the quality or detail of a content item such as the resolution for a video or the sample rate or sample range for a song, the rating of a content item such as a user rating, website rating, or reviewer rating, or any other measurable heuristic property of a content item. Each of these examples is a feature that could be associated with a content item in order to predict the rating or preference of the content item.

The content delivery system 150, therefore, may adjust or modify the ODR for classifiers and/or content items based on these factors. The ODR may be defined as the ratio of content delivered to content consumed, where the units for content delivered and content consumed may be bytes, counts (such as view counts and download counts), or any standard portion of a content item such as the length of time (e.g., one minute of media or one page of a book) or percentage of total length (e.g., 10% of a song or video). Hence, the ODR may represent a ratio of bytes, counts, or item portions, among other values.

The ODR may be generalized by counting units delivered and consumed with different weights, such as weights based on which type of network 130, such as WiFi or LTE, is used for delivery, or which type of network 130 the user device 110 is connected to during consumption. For example, a network operator may not care about the delivery cost of bytes delivered via WiFi, so they may compute an ODR that factors bytes delivered over WiFi with a weight of zero. Similarly, a network operator may count units delivered over 2G with a higher weight than units delivered over 4G, to reflect the real-world cost of delivery.

An ODR feature is a feature for which the measureable heuristic property is an ODR. In other words, the ODR feature is an ODR of some individual property of an object or phenomenon being observed. For example, when every content item is associated with a set of genres such as Sports, Science, or Politics, every content item has a set of category features that define the categories of the content item. Then, the ODR may be computed for each of these genres by calculating the ratio of content delivered to content consumed for all content associated with a given genre. For example, if 96 units of Sports-genre content have been delivered and 24 units of Sports-genre content have been consumed, then the Sports genre has an ODR of 96/24=4. In general, for every genre of a content item, an ODR feature for that genre may be associated with the content item. The value of each ODR feature is the ODR of the associated genre. Hence, an ODR feature is a feature of a content item that is an ODR.

ODR features can be constructed from any other feature. For example, features may have ODRs on a per-value basis. For a feature F with value X, an ODR can be constructed by calculating the ratio of content delivered to content consumed for content items that are associated with a feature F equal to X. In the previous example, an ODR was determined by calculating the ratio of content delivered to content consumed for content items with a genre feature equal to Sports. For example, ODR features could be further refined on a per-user basis by calculating the over delivery ratio over the subset of content that was delivered and/or consumed by a particular user.

The content delivery system 150, given a set of features, may then determine or calculate a rating or preference based on associating the content item with the set of features. To compute a rating or preference given a set of features, the content delivery system 150 may utilize an algorithmic process outputting a numerical rating on some predefined scale. In particular, the content delivery system 150 may determine multi-feature values via computations over a nonempty set of possibly similar features. For example, when a weighted combination of numerical features is used as the rating, a content item is associated with a set of ODR features, and the average feature ODR in this set of ODR features is an example of a possible numerical rating or preference that may be assigned to the given content item.

Specifically, a weighted ODR may be defined as a weighted average of a set of ODRs. Thus, given a set of ODR features, the content delivery system 150 may calculate a weighted ODR by taking the weighted average of the set of ODR features. The weighted ODR is therefore a multi-feature value that may be used in an algorithmic process to compute a rating or preference for a content item.

Features may have inherent similarities. For example, when a user is modeled as a feature of an instance of content delivery, then certain users may be more similar to each other than other users. But as a feature, a user may be different from other possible features, such as a category or statistical value. Hence, given conceptually similar features, the content delivery system 150 may define a similarity metric. A similarity metric function takes two or more inherently similar sets of features and outputs a numerical value representing the likeness of the feature sets. For example, all categories are inherently similar, but some are more similar than others. A category for Science would be more closely related to a Technology category than a Politics category.

The content delivery system 150, therefore, may model the user as a set of features and then apply a similarity metric between this user's feature set and all other possible users, producing a set of values representing how similar the given user is to each other user within the system. Thus, the content delivery system 150 may recommend content that has already been consumed by the 10 most similar users to the user, or recommend content that is similar to content that has already been consumed by the user.

As another example, if users are modeled as a set of numerical features, then the Euclidean distance between two vectors of numerical feature values is a valid, useful similarity metric, and the content delivery system 150 may use the distance when determining whether to pre-deliver a content item to a particular user by computing an ODR of that content item for every user. Thus, a weighted ODR may be computed over these per-user ODR values, weighted by the value of the user similarity metric compared to a given user, where the weighted ODR represents a predicted ODR for the given user for the given content item.

As described herein, in some embodiments, the content delivery system 150 may perform algorithms or processes to select certain content items to deliver to local storage at the user device 110, due to practical limits on how much content can be pre-delivered (e.g., available cache size, network delivery availability, user opportunity to view delivered content, and so on). For example, a larger amount of highly ranked content (e.g., content with low ODR values or equivalently high viewing probabilities) may be available online than can be pre-delivered and cached to the user device 110. The content delivery system 150, therefore, may utilize token-based algorithms in order to regulate the content items delivered to and locally stored at the user device 110.

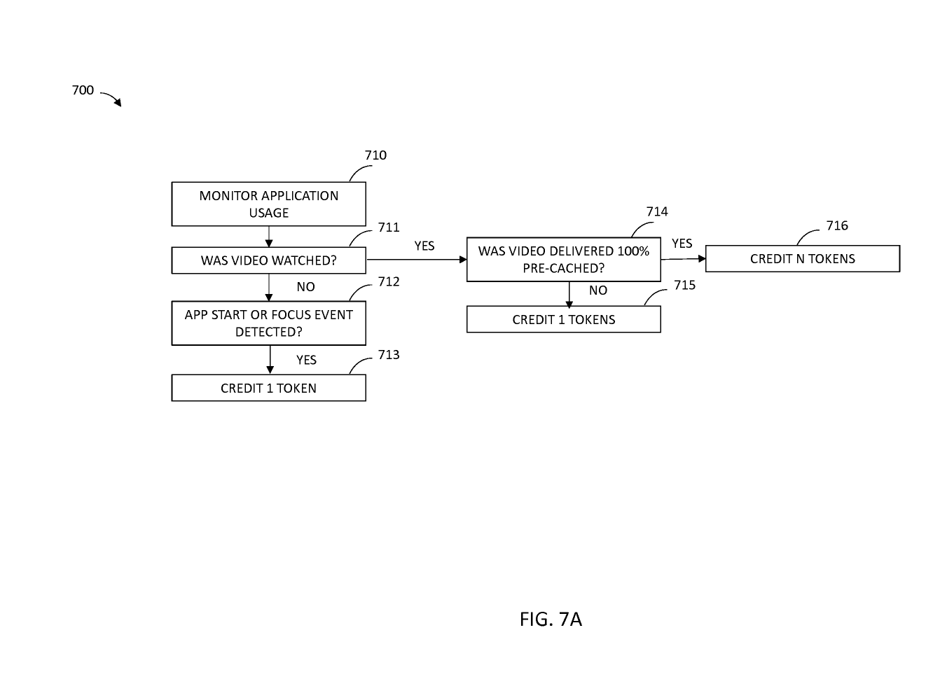

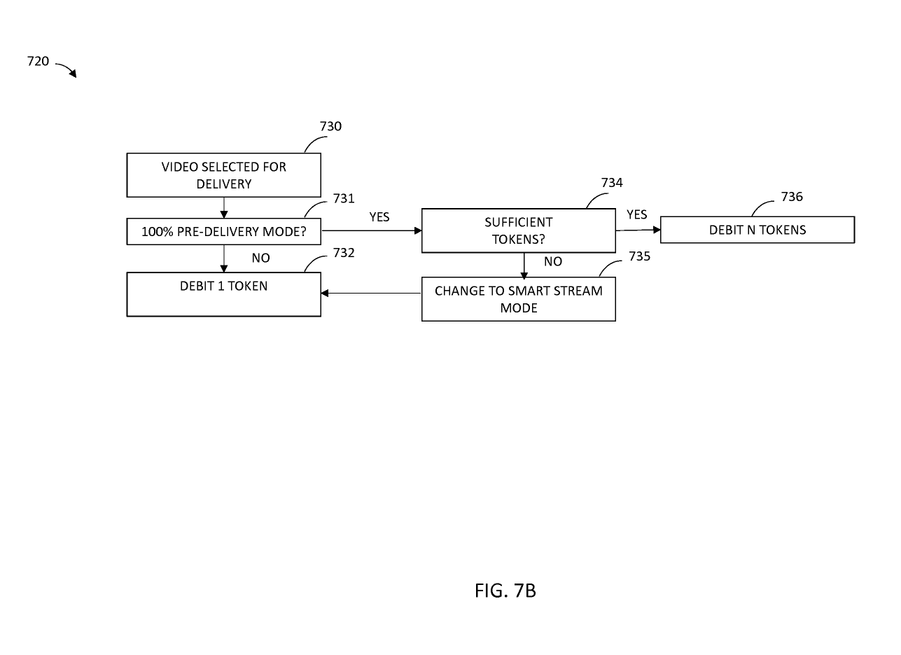

FIGS. 7A-7B are flow diagrams illustrating a method 700 for regulating the delivery of content to the user device. The method 700 may be performed by the content delivery system 150 and, accordingly, is described herein merely by way of reference thereto. It will be appreciated that the method 700 may be performed on any suitable hardware.

The content delivery system 150 may maintain a software token bucket, for one or more applications, that is pre-filled with a number of tokens. Thereafter, when a token credit event occurs, tokens are added to the bucket, and when a token debit event occurs, tokens are removed from the bucket.

FIG. 7A depicts a method for crediting a user with tokens in response to the consumption of content at the user device 110 via one or more user applications. In operation 710, the content delivery system 150 monitors the usage of the applications. In operation 711, the content delivery system 150 determines whether a user selects a video to watch. When the video was watched, the content delivery system 150 determines, in operation 714, the previously recorded delivery status of the content file. When the content is entirely pre-delivered or pre-cached, then, in operation 716, multiple N tokens are credited (e.g., added to the tokens in the token bucket). When the content is partially pre-delivered, then, in operation 715, a single token is credited.

In operation 712, after it was determined that the video was not watched, the content delivery system 150 determines whether the application was launched by the user or otherwise activated (e.g., brought to the foreground of the user screen), and, in operation 713, 1 token is credited. The content delivery system 150 may credit tokens in such cases in order to stimulate delivery of available content, e.g., for users that are actively using the application.

FIG. 7B depicts a method for debiting tokens from a user in response to the delivery of content to the user device 110. In operation 730, the content delivery system 150 determines whether a video has been selected for delivery. In operation 731, the content delivery system 150 determines whether the entire video is to be delivered. When a portion of the video is delivered, the content delivery system 150 proceeds to operation 732, and debits 1 token from the user.

When the content file is to be completely delivered, the content delivery system 150 proceeds to operation 743, and determine whether there is sufficient credit available in the token bucket of the user. When there is sufficient credit, the content delivery system 150, in operation 736, debits N tokens from the bucket, else the content delivery system 150, in operation 735, switches to a partial delivery mode (e.g., a smart stream mode) via which to deliver the content, and debits 1 token from the token bucket. In cases where a user has no available tokens (or insufficient tokens to employ the partial delivery mode), the content delivery system 150 may not pre-delivery content items to the user, until the user is credited with additional tokens.

In some embodiments, the content delivery system 150 may dynamically change the credit and/or debit allocation or de-allocation policy, depending on a user's streaming or usage account approaching a data cap limit, in order to slow or prevent pre-delivery that exceeds a data cap, and/or based on current network delivery conditions, among other things.

Thus, the content delivery system 150 may utilize algorithms that credit and/or debit tokens based on the type of content consumed, the type of consumption event, the type or amount of pre-delivery, and so on, in order regulate or otherwise manage the content items locally stored for a user at the user device 110. In other words, the content delivery system 150 may implement delivery content flow control procedures based on determining how often a user interacts with an application and/or the rate that the user consumes content in the application.

As described herein, in some embodiment, the content delivery system 150 may determine that a current capacity of local storage for the user device 110 is not sufficient to store the at least a portion of the selected subset of content items, calculate a retention score for content items within the local storage, identify one or more content items currently stored within the local storage having a retention score that is lower than a threshold retention score, and remove the identified one or more content items from the local storage. In other words, the content delivery system 150 may age out or otherwise remove content items from local storage that meet (or, don't meet) certain retention policy parameters.

The content delivery system 150 may employ various queuing policies (e.g., a content aging policy) to select which pre-delivered content files are removed, and in what order. For example, the content delivery system 150 may utilize a first-in-first-out policy to remove the files with the earliest caching time before files with later caching times.

In some embodiments, when content is stored in a local cache, the content delivery system 150 also stores various pre-delivery metrics or metadata, such as a weighted ODR value for the content, a viewing probability, the network type used to deliver the content, the time to deliver the content, the delivery start and finish time, the delivered content file size, the content type, the content priority, and so on. These parameters may be combined in a retention policy function to yield a retention score for the content file. The content delivery system 150 may periodically, or in response to an event trigger (e.g., the cache exceeding an upper fill limit) then re-evaluate retention scores to determine which content files to remove from the local cache.

For example, the content delivery system 150 may first remove content files with the lowest viewing probability. In some cases, a viewing probability may have changed over time to a revised weighted ODR for the classification associated with the content items. The content delivery system 150, may, as depicted in FIG. 6D, delete content items having lowest ranked viewing probabilities until the remaining content files meet an aging or retention threshold value (e.g., an aggregate cache content size below an upper size limit).

In some embodiments, the pre-delivered cached content viewing probability may change as a function of the amount of time it has remained in the cache. For example, the viewing probability for a content item may be constant for a time and then reduced according to the average time from content pre-delivery to selection by the user to play the content for a given application. An average time-to-view (TTV) establishes the time period over which the initially calculated viewing probability remains as originally assessed when the file was first placed in the cache. After a time corresponding to the average TTV for all content associated with a given application, the content viewing probability may be gradually reduced to zero. Thus, the viewing probability may change over time.

Thus, the content delivery system 150 may identify multiple content items associated with an application resident on the user device, the application capable of presenting the content items via an interface of the user device, determine a selection probability for each of the identified content items, the selection probability reflecting a likelihood of selection of a content items by a user of the user device, and retrieve content items that are assigned selection probabilities that satisfy a predetermined selection probability threshold. The content delivery system 150 may also implement and utilize token-based content delivery algorithms to control a volume of content delivery to the user device 110 and/or content aging and retention policies to manage the local cache of content items stored at the user device 110.

### Examples of Displaying Available Pre-Delivered Content

As described herein, in some embodiments, the content delivery system 150 presents a user interface that indicates a retrieval location for content items available for playback at a user device (e.g., locally from an onboard device cache or remotely from an off-device external server).

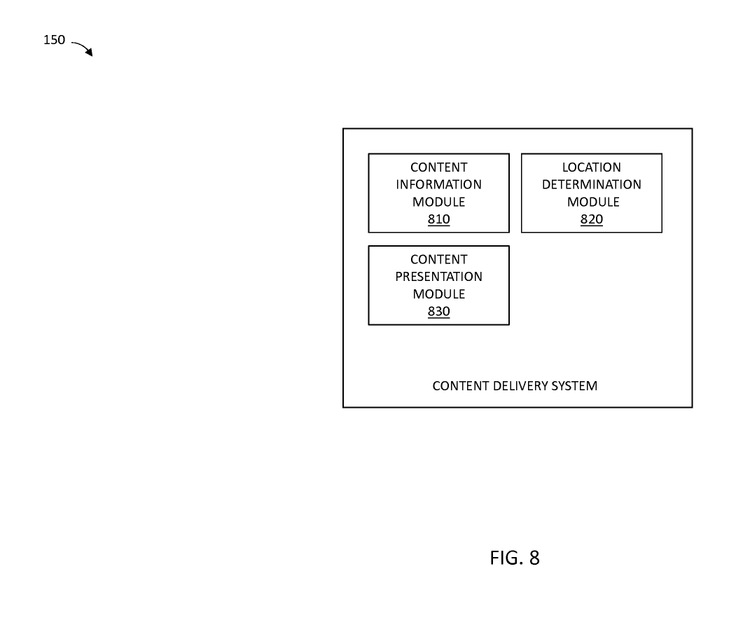

FIG. 8 is a block diagram illustrating other components of the content display system 150. The content discovery system 150 may include one or more modules and/or components to perform one or more operations of the content delivery system 150. The modules may be hardware, software, or a combination of hardware and software, and may be executed by one or more processors. For example, the content delivery system 150 may include a content information module 810, a location determination module 820, and a content presentation module 830.

In some embodiments, the content information module 810 is configured and/or programmed to identify content items available for playback via an application resident on a user device. For example, the content information module 810 may transmit information identifying the one or more applications resident on the user device (e.g., the application information file 192) to the content server, and receive information associated with content items, such as the content manifest file 194 from the policy server 140. As described herein, the content manifest file, or manifest file 194, may include a content request template and one or more uniform resource identifiers associated with content or content feeds located at the content server and available for retrieval by the user device.

In some embodiments, the location determination module 820 is configured and/or programmed to determine a current retrieval location for the identified content items available for playback via the application. The determined retrieval location may be a local storage location (e.g., local cache 118) associated with the user device and/or a remote storage location, such as the storage device 185 at the content server 120a. Therefore, the location determination module may determine that a first content item is currently stored in the local cache 118 resident on the user device 110 and that a second content item is currently stored at the storage location 185 remote from the user device 110 and/or determine that a first portion of a content item is stored in the local cache 118 resident on the user device 110 and that a second portion of the content item is stored at the storage location 185 remote from the user device 110.

In some embodiments, the content presentation module 830 is configured and/or programmed to present a user interface that includes user-selectable elements associated with the content items available for playback via an application resident on a user device, the user-selectable elements displaying information identifying the content items and information identifying the retrieval location for the content items. The content presentation module 830 may present information reflecting that the one or more content items have been pre-delivered to the local cache 118 and/or reflecting that at least a portion of the one or more content items have been pre-delivered to the local cache. For example, the content presentation module 830 may present a list of user-selectable elements in an order based on the retrieval locations for the content items, various indicators, symbols, or other graphical elements that are representative of the retrieval locations, and so on.

In some cases, the content presentation module 830 may highlight a user-selectable element associated with the certain content item to indicate a changed retrieval location for the certain content item (the content item has changed from being partially downloaded to the user device 110 to being completely downloaded to the user device 110).

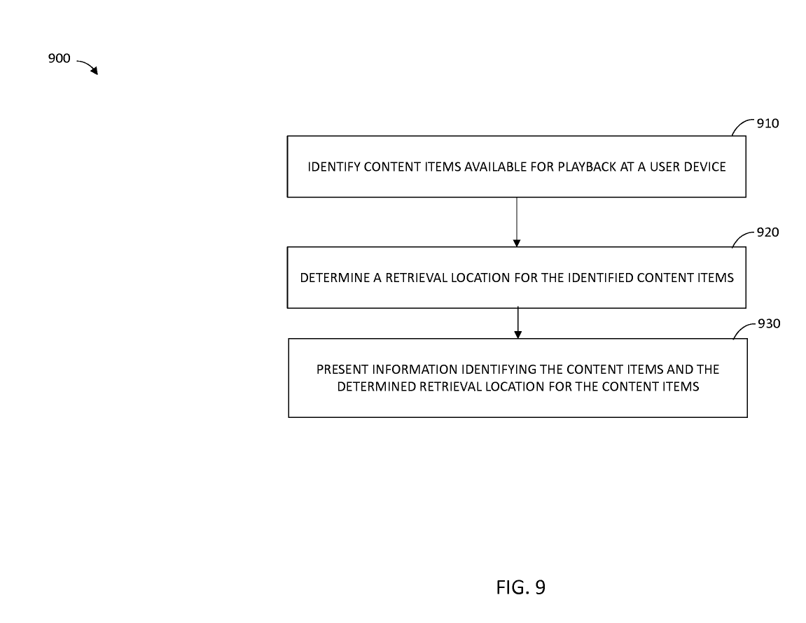

As described herein, the content delivery system 150 may perform various different methods, processes, and/or algorithms when displaying content items available for playback. FIG. 9 is a flow diagram illustrating a method 900 for presenting content available for playback at a user device. The method 900 may be performed by the content delivery system 150 and, accordingly, is described herein merely by way of reference thereto. It will be appreciated that the method 900 may be performed on any suitable hardware.

In operation 910, the content delivery system 150 identifies content items available for playback via an application resident on a user device. For example, the content information module 810 may transmit information identifying the one or more applications resident on the user device (e.g., the application information file 192) to the content server, and receive information associated with content items, such as the content manifest file 194 from the policy server 140. As described herein, the content manifest file, or manifest file 194, may include a content request template and one or more uniform resource identifiers associated with content or content feeds located at the content server and available for retrieval by the user device.

In operation 920, the content delivery system 150 determines a retrieval location for the identified content items available for playback via the application. For example, the location determination module may determine that a first content item is stored in the local cache 118 resident on the user device 110 and that a second content item is stored at the storage location 185 remote from the user device 110 and/or determine that a first portion of a content item is stored in the local cache 118 resident on the user device 110 and that a second portion of the content item is stored at the storage location 185 remote from the user device 110.

In operation 930, the content delivery system 150 presents a user interface that includes user-selectable elements associated with the content items available for playback via an application resident on a user device, the user-selectable elements displaying information identifying the content items and information identifying the retrieval location for the content items. For example, the content presentation module 830 may present information reflecting that the one or more content items have been pre-delivered to the local cache 118 and/or reflecting that at least a portion of the one or more content items have been pre-delivered to the local cache, such as a list of user-selectable elements in an order based on the retrieval locations for the content items, various indicators, symbols, or other graphical elements that are representative of the retrieval locations, and so on.

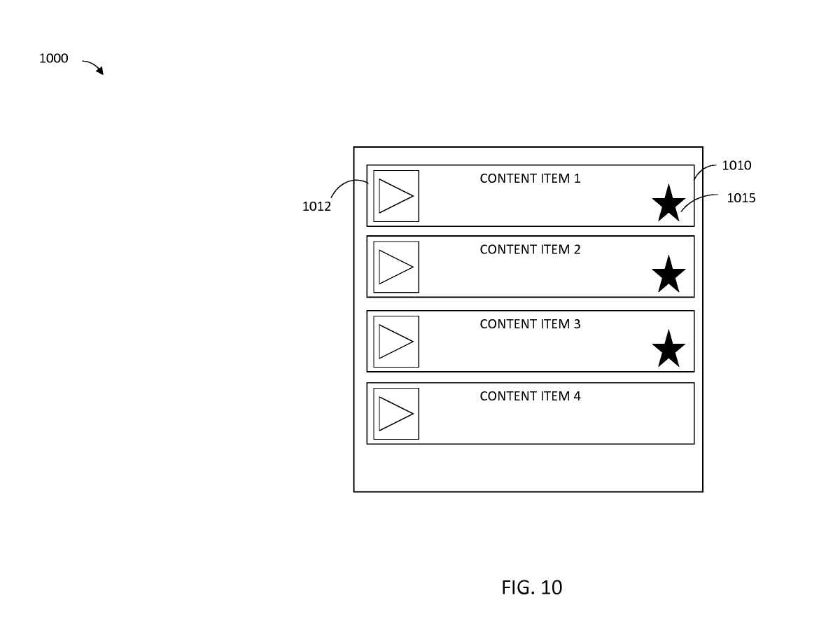

FIG. 10 is a display diagram illustrating an example user interface 1000 that presents information identifying content available for playback. The user interface presents user-selectable elements 110 associated with content items available for playback with one or more applications resident on the user device 110. The user-selectable elements may display description information 1012, such as a title or description of the content item, the type of content item, and so on, as well as an indicator or symbol 1015 that indicates the content item is locally stored on the user device 110.

The user interface 1000, therefore presents the content items with indicators or other elements, such that users can determine which content is locally cached and which content is not cached. For example, the user interface may include a list of user-selectable graphical or text links to available content items. Links corresponding to content that has been pre-delivered (at least in part) are indicated with an icon, a pop-up message (e.g., when the user hovers over the selected item) or by other graphical decorations, such as using unique colors, symbols, outlines, bold fonts, underline, highlights, and so on.

In some embodiments, the user interface 1000 may only display content that has been pre-delivered, may display pre-delivered content at the top of a scrollable list of links or selectable items, may sort the links in an order of viewing probability, may group links to pre-delivered content within separate interfaces, and so on.

Therefore, in some embodiments, the content delivery system 150 may identify content items stored in a local cache of the user device 110 and display, along with description information for the content items, a display element that indicates the identified content items are stored in the local cache of the user device 110. The display elements may indicate or represent the content items that have been pre-delivered to the local cache of the user device in anticipation of selection by a user of the user device 110, a content item where a portion of the content item has been pre-delivered to the local cache of the user device in anticipation of selection by a user of the user device, and/or full copies of the content items stored in the local cache of the user device, among other things.

Although aspects of the present technology have been described with respect to specific examples, embodiments of the present technology are not limited by these examples. For example, persons of skill in the art will recognize that pre-delivering content to user devices may be performed according to various other algorithms and processes without departing from the scope or spirit of the present technology.

What is claimed is:

1. A method, comprising:
identifying content items available for playback via an application resident on a user device;
determining a current retrieval location for the identified content items available for playback via the application; and
presenting a user interface that includes user-selectable elements associated with the content items available for playback via an application resident on a user device, the user-selectable elements displaying information identifying the content items and information identifying the retrieval location for the content items.

2. The method of claim 1, wherein the retrieval location includes a local storage location associated with the user device; and wherein the information identifying the retrieval location for the content items includes an indicator representative of the local storage location displayed along with a name assigned to the content items.

3. The method of claim 1, further comprising:
pre-delivering one or more content items to a local cache resident on the user device;
wherein the user-selectable elements presented by the user interface display information reflecting that the one or more content items have been pre-delivered to the local cache.

4. The method of claim 1, further comprising:
pre-delivering at least a portion of one or more content items to a local cache resident on the user device;
wherein the user-selectable elements presented by the user interface display information reflecting that at least a portion of the one or more content items have been pre-delivered to the local cache.

5. The method of claim 1, wherein determining a retrieval location for the identified content items available for playback via the application includes determining that a first content item is stored in a local cache resident on the user device and that a second content item is stored at a storage location remote from the user device.

6. The method of claim 1, wherein determining a retrieval location for the identified content items available for playback via the application includes determining that a first portion of a content item is stored in a local cache resident on the user device and that an second portion of the content item is stored at a storage location remote from the user device.

7. The method of claim 1, wherein presenting a user interface that includes user-selectable elements associated with the content items available for playback via an application resident on a user device includes presenting a list of user-selectable elements in an order based on the retrieval locations for the content items.

8. The method of claim 1, further comprising:
determining a retrieval location for a certain content item has changed; and
highlighting a user-selectable element associated with the certain content items to indicate the changed retrieval location for the certain content item.

9. A system, comprising:
a content information module that identifies content items available for playback via an application resident on a user device;
a location determination module that determines a retrieval location for the identified content items available for playback via the application; and
a content presentation module that presents a user interface that includes user-selectable elements associated with the content items available for playback via an application resident on a user device, the user-selectable elements displaying information identifying the content items and information identifying the retrieval location for the content items.

10. The system of claim 9, wherein the retrieval location includes a local storage location associated with the user device; and wherein the information identifying the retrieval location for the content items includes an indicator representative of the local storage location displayed along with a name assigned to the content items.

11. The system of claim 9, further comprising:
a content retrieval module that causes pre-delivery of one or more content items to a local cache resident on the user device;
wherein the user-selectable elements presented by the user interface display information reflecting that the one or more content items have been pre-delivered to the local cache.

12. The system of claim 9, further comprising:
a content retrieval module that causes pre-delivery of one or more content items to a local cache resident on the user device;
wherein the user-selectable elements presented by the user interface display information reflecting that at least a portion of the one or more content items have been pre-delivered to the local cache.

13. The system of claim 9, wherein the location determination module determines that a first content item is stored in a local cache resident on the user device and that a second content item is stored at a storage location remote from the user device.

14. The system of claim 9, wherein the location determination module determines that a first portion of a content item is stored in a local cache resident on the user device and that an second portion of the content item is stored at a storage location remote from the user device.

15. The system of claim 9, wherein the content presentation module presents a list of user-selectable elements in an order based on the retrieval locations for the content items.

16. The system of claim 9, wherein the location determination module determines a retrieval location for a certain content item has changed; and
wherein the content presentation module highlights a user-selectable element associated with the certain content item to indicate the changed retrieval location for the certain content item.

17. A computer-readable storage medium whose content, when executed by a user device, cause the user device to perform operations for displaying content items available for playback via an application resident on the user device, the operations comprising:
identifying content items stored in a local cache of the user device; and
displaying, along with description information for the content items, a display element that indicates the identified content items are stored in the local cache of the user device.

18. The computer-readable medium of claim 17, wherein identifying content items stored in a local cache of the user device includes identifying content items that have been pre-delivered to the local cache of the user device in anticipation of selection by a user of the user device.

19. The computer-readable medium of claim 17, wherein identifying content items stored in a local cache of the user device includes identifying a content item where a portion of the content item has been pre-delivered to the local cache of the user device in anticipation of selection by a user of the user device.

20. The computer-readable medium of claim 17, wherein displaying a display element that indicates the identified content items are stored in the local cache of the user device includes displaying indicators that reflect full copies of the content items are stored in the local cache of the user device.
